(19) United States
(12) Patent Application Publication
(10) Pub. No.: US 2011/0090704 A1
(43) Pub. Date: Apr. 21, 2011

(54) Molded Fluorescent Glass Lens and Manufacturing Method Thereof

(76) Inventors: San-Woei Shyu, Taipei (TW); Chien-Yi Huang, Taipei (TW); Ching-Wei Sun, Taipei (TW); Wen-Huang Liu, Taipei (TW)

(21) Appl. No.: 12/199,266

(22) Filed: Aug. 27, 2008

(30) Foreign Application Priority Data
Dec. 20, 2007 (TW) 096149015

(51) Int. Cl. F21V 5/00; C03B 23/00; C03C 17/00

(52) U.S. Cl. 362/326; 65/102; 65/60.1

(57) ABSTRACT

A molded fluorescent glass lens and a manufacturing method thereof are disclosed. Firstly, coat fluorescent material on surface of a glass preform or a cavity of a mold core. Then by glass precision molding, the mold core is heated and pressured for casting the glass preform into a molded fluorescent glass lens. The fluorescent glass lens not only has shape and optical properties of the molded forming lens, but also has fluorescent properties from a fluorescent surface layer formed by fluorescent material inserted into the glass. Thus the produced molded fluorescent glass lens is applied to road reflectors, white light LED or other optical elements for use.

### BACKGROUND OF THE INVENTION

The present invention relates to a molded fluorescent glass lens and a manufacturing method thereof, especially to a glass lens with a fluorescent surface made from fluorescent material and glass preform by precision glass molding technique and a manufacturing method thereof.

In order to make the glass lens with preset shape or optical properties (surfaces), the most common technique being used is glass precision molding. A glass preform is put into an upper mold and a lower mold, heating to the glass transition point to soften the glass, then pressing the upper mold and lower mold to transfer the casting surfaces into forming the optical surfaces. After annealing (cooling until a preset time), the optical glass lens is released by separation of the molds. By such way, the optical lens is produced TW265913, TW093128938, U.S. Pat. No. 6,766,661, US2005/028558, US2007/0171535, US2004/194508, US2007/204655, US2007/204654, U.S. Pat. No. 5,762,673, JP07-315853, JP11-171555 etc. The glass preform can be solid glass ball, glass gob, glass disk, glass cube, resemblance product, or a melting glass drop. In glass precision molding processes, carbon rich material or eleaser for de-molding is added to prevent the glass lens from adhering to the mold, as disclosed by US2006/026992. The material used for de-molding can be carbon film (in U.S. Pat. No. 5,851,252), inorganic oxide or novel composition (in U.S. Pat. No. 4,071,368, U.S. Pat. No. 5,720,791 JP09-227137). The de-molding material is leading to increase the complexity and cost during manufacturing processes.

A fluorescent glass lens is a glass lens with fluorescent properties that has been broadly applied to white LED (light emitting diode) or optical elements. Refer to JP2001-184921, JP2003-197978, JP2006-052345, JP2002-252372, US2004/257797, U.S. Pat. No. 6,956,243, US2007/114914, DE202007001048.6 etc., light emitted from LED chip passes the lens with fluorescent properties to excite fluorescence and generate white light and the devices are called wavelength-converting elements. They can be made from plastic or glass. Another application in road surface light reflectors with fluorescent color is disclosed by U.S. Pat. No. 5,825,544 & U.S. Pat. No. 6,398,369. Thus, the wavelength-converting elements made from glass are fluorescent glass lens that have been applied to various industries.

In currently, the techniques of package of white light LED are instantiated RGB chip with red/ green/blue dies, or, blue LED with wavelength-converting elements having yellow phosphors, or, UV LED with wavelength-converting elements having RGB Phosphors/ZnSe Phosphor. In a conventional way, the fluorescent glass lens can be produced by enameling, as shown in CN1557777, yet it is not precise. In the status, the fluorescent glass lens for wavelength-converting element can be manufactured by glass molded technique with different processes. As shown in FIG. 3 referring to US2002/007049, US2004/166320, JP2003-258308, JP2006-052345, JP2005/011429 etc., a fluorescent glass lens is formed by the phosphor particles mixed with glass material. The phosphors 3 are evenly mixed into glass to form a preform 8 that is treated by glass molding to generate a fluorescent glass lens 2.

Although the fluorescent glass lens 2 has certain shape, optical properties and fluorescent properties of the molded lens, its mechanical strength is reduced due to addition of phosphor material. Another way, as shown in FIG. 1, referring to JP63-169370, JP57-113546, JP2001-215301, a glass lens 2 is pre-produced by glass molding, then a fluorescent film 5 is pressed (or attached) on the glass lens 2. A further way, as shown in FIG. 2, referring to JP08-017343 JP2004-158695, JP2005-246926, JP2004-088009, is to set fluorescent materials 3 between a glass lens 2a and a transparent layer 6, then being pressed to form a fluorescent glass lens. These different manufacturing approaches provide complicated processes and higher cost.

Due to broad applications of the fluorescent glass lens and fast, conveniently processes of the glass precision molding, there is a need to develop a fluorescent glass lens with simple structure made by the glass precision molding so that not only complicated processes of mixing phosphors into glass material or phosphors in a sandwich structure can be avoid, there is no need to add the de-molding releaser. Therefore, the manufacturing efficiency is improved, the cost is reduced and the progress of industries is enhanced.

### SUMMARY OF THE INVENTION

Therefore it is a primary object of the present inven on to provide a molded fluorescent glass lens and a manufacturing method thereof that produce a molded glass lens with certain shape, optical properties and fluorescent properties by molded forming. The fluorescent properties evolve from a fluorescent surface made by phosphors pressed into glass material. Firstly, the phosphor material is attached on surface of a glass preform or a cavity of a mold core. Then a molded glass lens is cast by glass precision molding. During the heating and pressing processes of casting, the phosphor material is inserted into surface of a glass layer of the molded lens. Thereby, the molded fluorescent glass lens overcomes shortages of conventional lens such as insufficient mechanical strength or aging of plastic material. Moreover, problems such as low thermal resistance of plastic material and high cost due to complicated manufacturing processes can also be solved. By simplifying manufacturing processes of the fluorescent glass lens, the cost is reduced and automatic manufacturing is facilitated. In addition, the fluorescent material replaces addition of the releaser so that the processes are further simplified.

It is another object of the present invention to provide a molded fluorescent glass lens and a manufacturing method thereof. The glass forms used can be a solid ball, disc, cube or gob or melting glass drop. Because both the glass preform and melting glass drop can be used and there is no restriction on glass lens and the mold core, the manufacturing method of the present invention is more convenient for producers.

It is a further object of the present invention to provide a molded fluorescent glass lens and a manufacturing method thereof. The way to attach the fluorescent material depends on producers and can be by hand-painting, powder dispersion, air spray gun or electrostatic coating so that the attaching is even and fast. There are various coating ways producers can choose and this is more easy and convenient. Moreover, the fluorescent material being used is durable under high temperature environment such as at the glass transition temperature and the fluorescent material includes inorganic phosphors such as YAG phosphor, TAG phosphor or nitride Phosphor.

According to the manufacturing method of the present invention, during the casting process, the glass preform and the mold core are heated and pressed so that the fluorescent material is simultaneously inserted into surface layer of the glass preform and is called Phosphor powder Inserted Glass Surface (PIGS) manufacturing technique. Because the fluorescent material has similar function as the releaser, the glass lens will not adhere to the mold core. This is another object of the present invention to prevent adhesion of the glass lens to the mold core.

### BRIEF DESCRIPTION OF THE DRAWINGS

FIG. 1 to FIG. 3 are schematic drawings showing fluorescent glass lenses manufactured by conventional technique;

FIG. 4A is an embodiment of a molded fluorescent glass lenses according to the present invention;

FIG. 4A′ is a partial enlarged view of the embodiment in FIG. 4A;

FIG. 4B is another embodiment of a molded fluorescent glass lenses with red fluorescent material (represented by ∘), yellow fluorescent material (represented by x), and blue fluorescent material (represented by Δ) according to the present invention;

FIG. 4 B′ is a partial enlarged view of the embodiment in FIG. 4B;

FIG. 5 is a schematic drawing showing the attaching of fluorescent material by a powder dispenser;

FIG. 6 is a schematic drawing showing the attaching of fluorescent material by a brush;

FIG. 7 is a schematic drawing showing the attaching of fluorescent material by an electrostatic coating device;

FIG. 8 is a schematic drawing showing manufacturing process of a gob-like glass preform according to the present invention;

FIG. 9 is a schematic drawing showing manufacturing process of a ball-like glass preform according to the present invention;

FIG. 10 is a schematic drawing showing manufacturing process of a cube-like glass preform according to the present invention;

FIG. 11 is a schematic drawing showing manufacturing processes of melting glass drop according to the present invention;

FIG. 12 is a schematic drawing showing temperature and pressure being used during manufacturing processes.

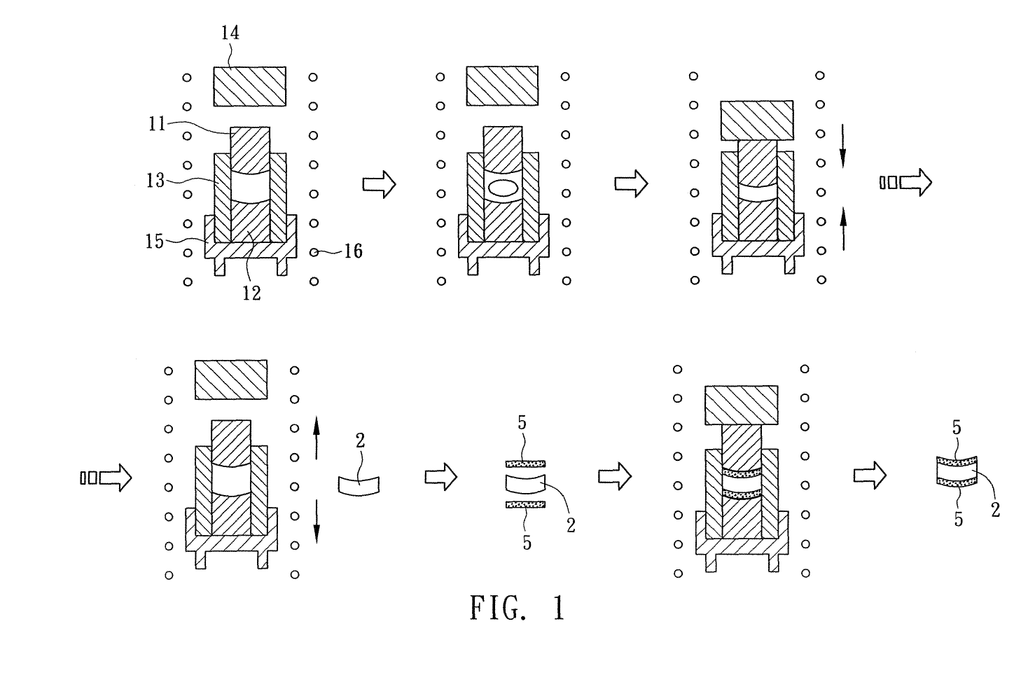

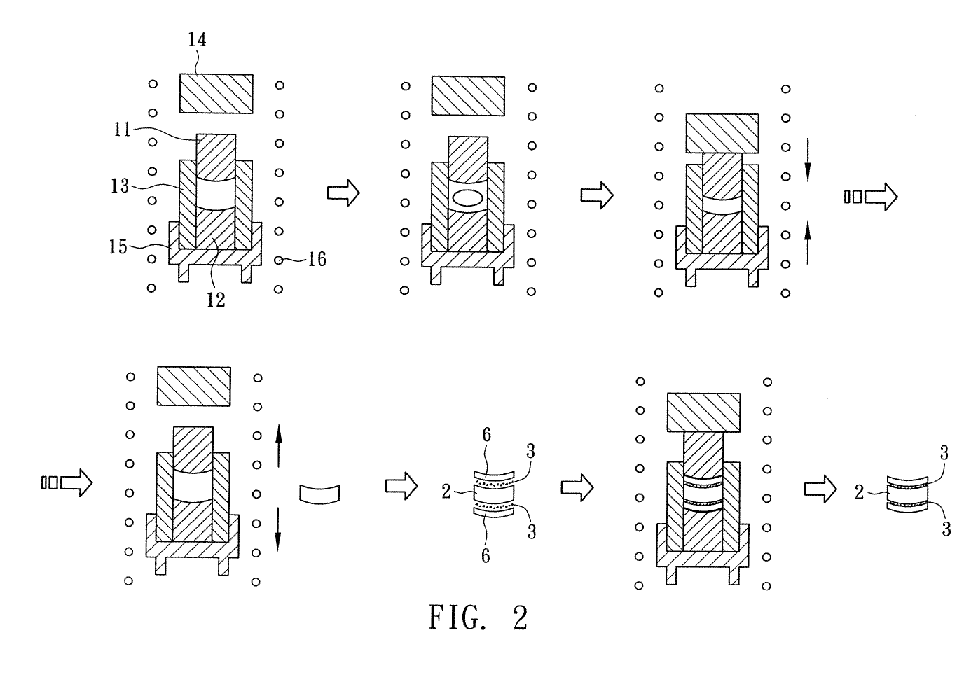

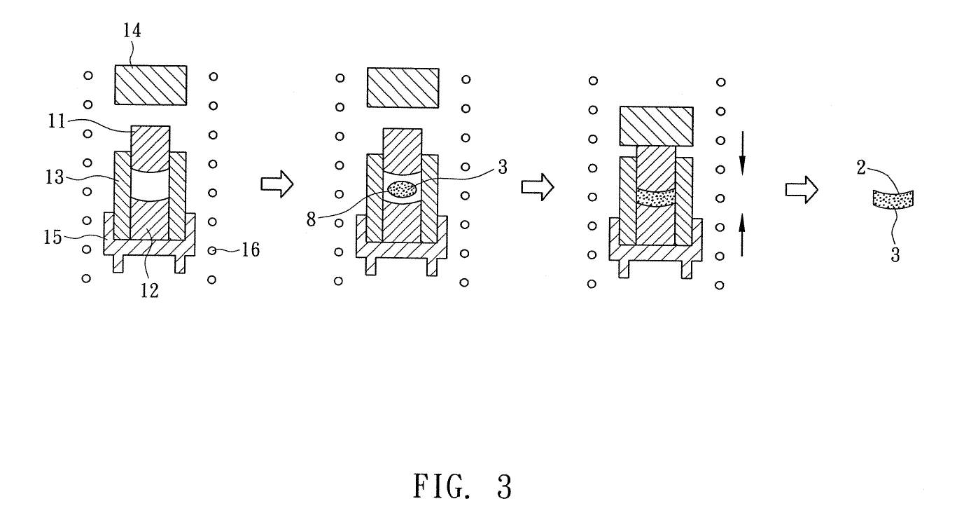

### DETAILED DESCRIPTION OF THE PREFERRED

### Embodiment

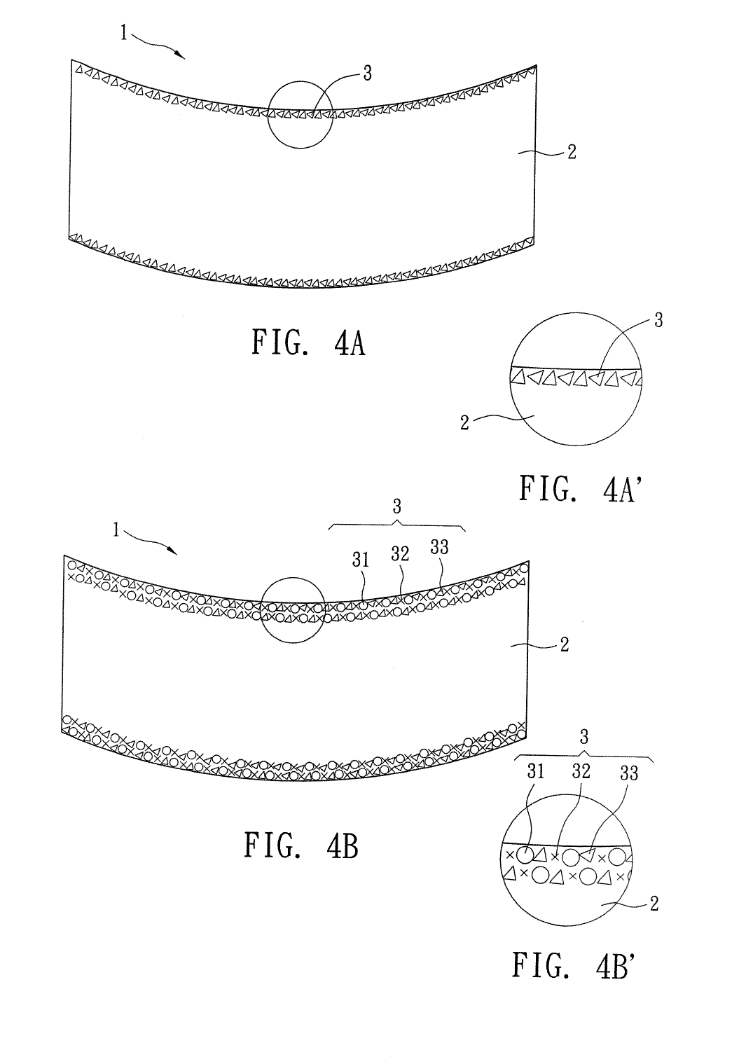

Refer to FIG. 4A & FIG. 4A′, a molded fluorescent glass lens 1 according to the present invention includes a glass lens 2 with preset lens shape and a fluorescent material 3 inserted into surface of the glass lens 2 by glass molding. The molded fluorescent glass lens 1 features on that the fluorescent material 3 is inserted into surface of the glass lens 2 by the glass molding method so that the glass lens 2 has preset lens shape, optical properties and fluorescent properties. There is no limit on the fluorescent material 3 and the glass material of the glass lens 2. The followings are two embodiments of the molded fluorescent glass lens 1 according to the present invention.

### The First Embodiment

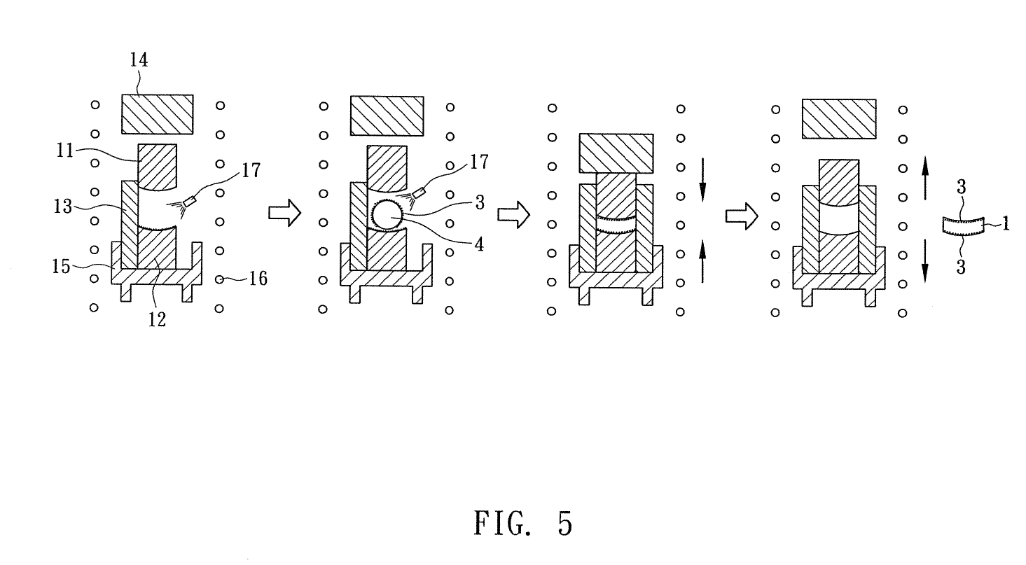

Refer to FIG. 4A & FIG. 4A′, a molded fluorescent glass lens 1 of this embodiment is applied to the white-light LED. After being excited, blue light from the GaN LED passes the molded fluorescent glass lens 1 and converts to the white-light through wavelength conversion. The glass lens 2 of the molded fluorescent glass lens 1 is made of B₂O₃ (boron trioxide) and SiO₂ (silicon dioxide) while the fluorescent material 3 is yttrium-aluminum-garnet (YAG) phosphor including Cerium (Ce) and terbium (Tb). Refer to FIG. 5, a glass preform 4 is set into an upper mold core and a lower mold core 11, 12 and then attach fluorescent material 3 on the upper mold core and/or the lower mold core 11, 12 or the glass preform 4 by painting or spraying. Heat the mold until the temperature is over the glass softening point. Then preform a casting process that close-up the upper mold core and the lower mold core 11, 12. After being cooled until a preset time, the upper mold core and the lower mold core 11, 12 are separated from each other to obtain the molded fluorescent glass lens 1. There is no restriction on attaching ways and shapes of the glass preform 4.

Once terbium-aluminum garnet (TAG) phosphor is used as the fluorescent material 3, the glass lens 2 is preferred to use low temperature glass. The TAG phosphor is garnet phosphor containing Cerium (Ce), terbium (Tb), Yttrium (Y), Gadolinlium (Gd), and Lanthanum (La) etc. while the glass lens 2 consists of Na₂CO₃, H₃BO₃, SiO₂ and TiO₂. The fluorescent material 3 is preferred Nitride Phosphor formed by Group II A metal or rare earth metal elements sintering in nitrogen.

### The Second Embodiment

Refer to FIG. 4B & FIG. 4B′, the fluorescent material 3 is a mixture of red fluorescent material (represented by ∘), yellow fluorescent material (represented by x), and blue fluorescent material (represented by Δ). After glass molding processes, a molded fluorescent glass lens 1 with the fluorescent material 3 having red, yellow and blue colors is produced. The molded fluorescent glass lens 1 of this embodiment is applied to white-light LED or UV-LED. After being excited, the UV light from the UV-LED emits onto the molded fluorescent glass lens 1 with the fluorescent material 3 having red, yellow and blue colors on surface thereof so as to generate white light. As to the inorganic fluorescent material 3 having red, yellow and blue colors, the yellow fluorescent material 32 is YAG phosphor, TAG phosphor or nitride phosphor; the red (inorganic) fluorescent material 31 consists of Y₂O₃ (Yttrium Oxide and) and Eu₂O₃ (Europium Oxide); the blue (inorganic) fluorescent material 33 is ZnS sintered compound added with silver (Ag) and chloride (Cl).

The followings are seven embodiments of a manufacturing method of the molded fluorescent glass lens 1 according to the present invention.

### The First Embodiment

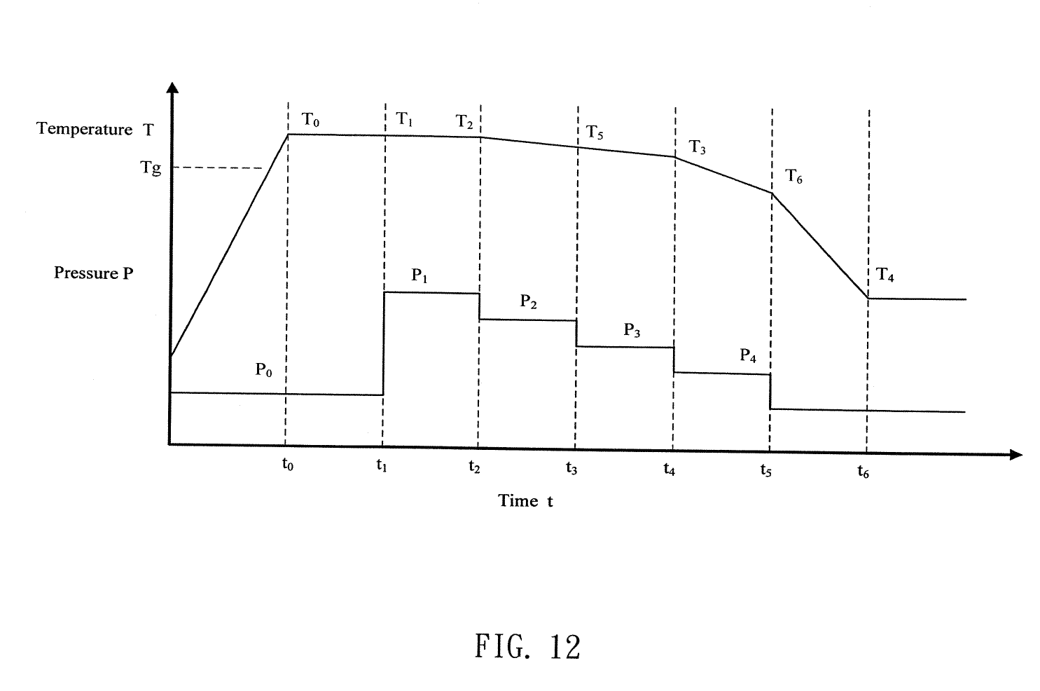

Refer to FIG. 5, the first step is to prepare a glass preform 4. Step 2: use a powder dispenser 17 to attach the fluorescent material 3 on surface of a cavity of a lower mold core 12. The third step is to put the glass preform 4 into the cavity of the lower mold core 12 attached with the fluorescent material 3. Step 4: use powder dispenser 17 to spray the fluorescent material 3 onto surface of the glass preform 4. Step 5: heat the upper and the lower mold cores 11, 12 until the temperature is over the glass transition temperature Tg of the glass preform 4. In this embodiment, the temperature is 20° C. higher than Tg and the glass preform 4 is melt. Then increase the pressure P₁ (in this embodiment P₁=1.25KN) on the upper and the lower mold cores 11, 12. No the upper and the lower mold core 11, 12 respectively get the pressure from the upper and the lower mold bases 14, 15 and relatively move upward/downward. During the casting process of closing the upper and the lower mold cores 11, 12, the fluorescent aterial 3 is inserted into surface of the glass preform 4 and the softened glass preform 4 is cast into a glass lens with preset shape and optical properties (surfaces). The relationship of the temperature and the pressure used in this embodiment is shown in FIG. 12. Step 6: cool the upper and the lower mold cores 11, 12 until the to perature is lower then the glass transition temperature Tg (in this embodiment is 240° C.). and reduce the pressure to separates the mold cores 11, 12. Step 7: release the molded fluorescent glass lens 1 from the lower mold core 12.

The temperature and the pressure control process in the step 5 are shown in FIG. 12. The upper and the lower mold cores 11, 12 are heated until T₀ that is 10-80 degrees Celsius higher than the glass transition temperature. In this embodiment, the T₀=Tg+20° C. Now the pressure is not increased yet and it's P₀=0.01 KN. After a certain period of time, the glass preform 4 begins softening and increase the pressure into P₁ at the time of t₁ and keep such pressure until the time of t₂. In this embodiment, the P₁=10 KN. At the time of t₂, cool down the temperature gradually from. T₁ to T₅ ` T₃ to T₆, and the pressure is reduced in Stair-like mode, from P₁ to P₂, P₃, P₄. The T₆ is 10° C.˜30° C. lower than the Tg and in this embodiment, T₆=Tg−20° C., P₄=1.2 KN. At the time of t₅, the pressure is reduced to P₄ and the temperature is keeping down to T₄. When the temperature is T₄, separate the upper and the lower mold cores 11, 12 at the time of t₆ to get the product. In this embodiment, T₄ is 200° C.

### The Second Embodiment

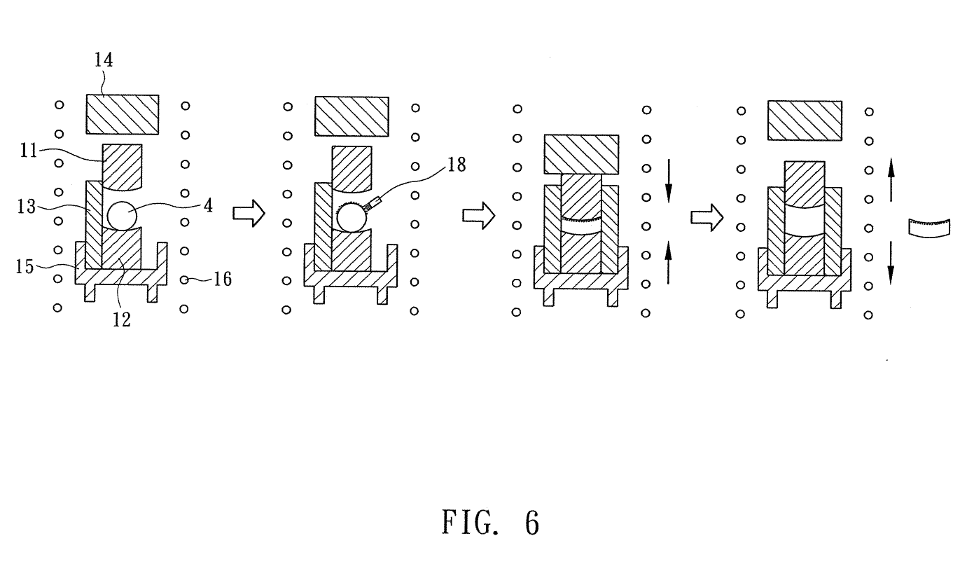

Refer to FIG. 6, step 1: prepare a glass preform 4. Step 2: put the glass preform 4 into a cavity of a second core 12. Step 3: use a brush 18 to attach the fluorescent material 3 onto a preset area whose width is about 3mm on surface of the glass preform 4. Step 4: heat the upper and the lower mold cores 11, 12 until the temperature is over 20° C. of the glass transition temperature Tg and the glass preform 4 becomes soft. Increase the pressure P₁=10 KN on the upper and the lower mold cores 11, 12 to run the molding process so that the fluorescent material 3 is inserted into surface of the fluorescent material 3 and the soft glass preform 4 is cast by the mold cores 11, 12 into a glass lens with preset shape and optical properties. Step 5: cool the upper and the lower mold cores 11, 12 until the temperature is lower then the glass transition temperature Tg (in this embodiment is about (240° C.), then reduce the pressure to separates the mold cores 11, 12. Step 6: release the molded fluorescent glass lens 1 with a 3 mm width fluorescent layer on a single optical surface from the lower mold core 12.

### The Third Embodiment

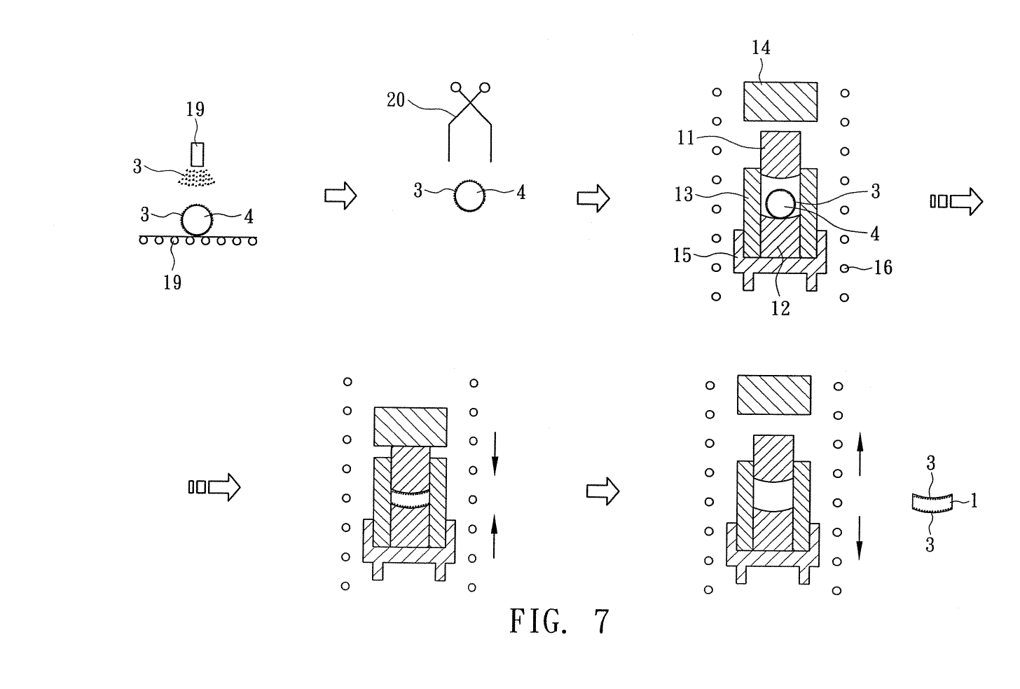

Refer to FIG. 7, step 1: prepare a glass preform 4. Step 3: use an electrostatic coating device 19 to attach the fluorescent material 3 onto the glass preform 4. Step 2: put the glass preform 4 with the fluorescent material 3 into a cavity of the lower mold core 12 by a clam 20. Step 4: heat the upper and the lower mold cores 11, 12 until the temperature is over 20° C. of the glass transition temperature Tg and the glass preform 4 becomes soft. Increase the pressure P₁=10 KN on the upper and the lower mold cores 11, 12 to run the molding process so that the fluorescent material 3 is inserted into surface of the fluorescent material 3 and the soft glass preform 4 is cast by the mold cores 11, 12 into a glass lens with preset shape and optical properties. Step 5: cool the upper and the lower mold cores 11, 12 until the temperature is lower than the glass transition temperature Tg, then reduce the pressure to separates the mold cores 11, 12. Step 6: release the molded fluorescent glass lens 1 from the lower mold core 12. Since, the electrostatic coating device 19 is used to attach the fluorescent material 3 onto the glass preform 4 by off line way and then the glass preform 4 is put onto the mold for molding. Thus the fluorescent material 3 is evenly distributed on the glass preform 4 and the automatic equipments can be used to increase yield and productivity.

### The Fourth Embodiment

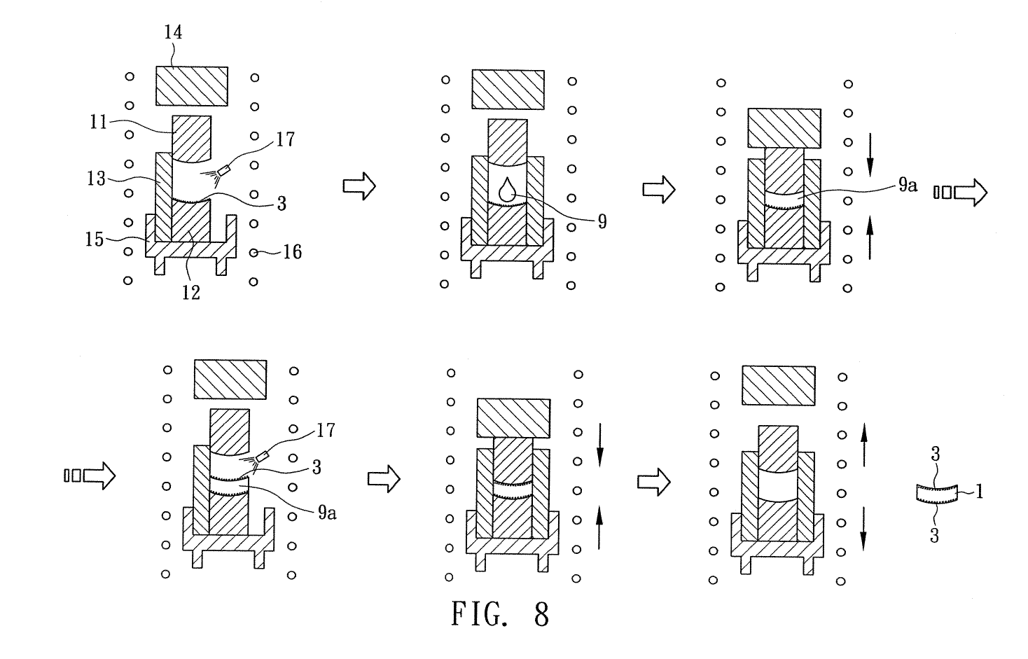

Refer to FIG. 8, step 1: prepare a gob-like glass preform 9. Step 2: use a powder dispenser 17 to attach the fluorescent material 3 on surface of a cavity of a lower mold core 12. Step 3: put the gob-like glass preform 9 into the cavity of the lower mold core 12. Step 4: run a first heating and pressuring molding process, pre-casting gob-like glass preform 9 into a glass preform 9a with appearance near the product. Step 5: use powder dispenser 17 to spray the fluorescent material 3 on the glass preform 9a. Step 6: run a second heating and pressuring molding process this is called precision molding, the same as the step 5 in the first embodiment. Step 7: cool down and reduce the pressure. Step 8: release the molded fluorescent glass lens 1.

### The Fifth Embodiment

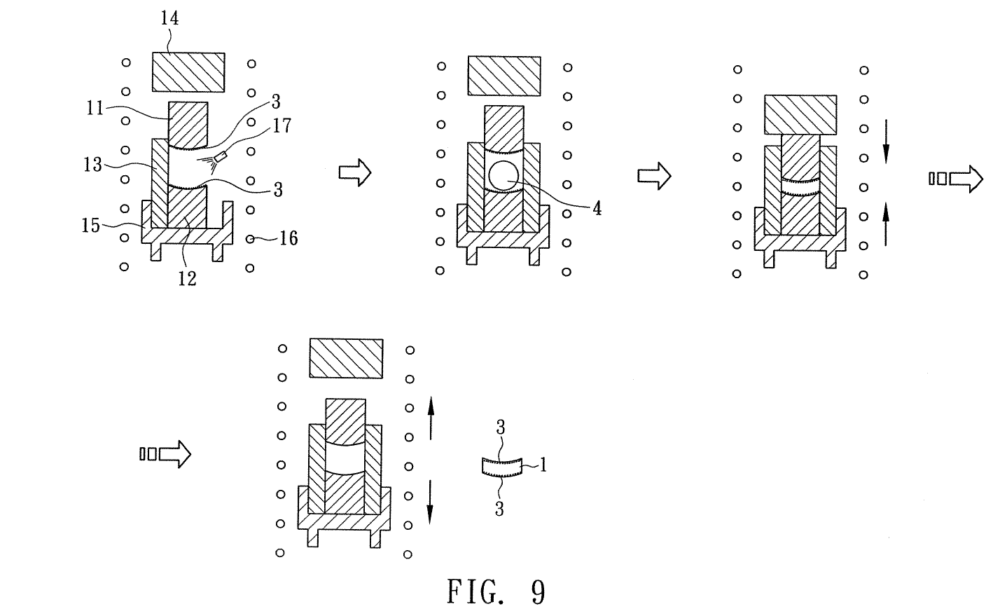

Refer to FIG. 9, the first step is to prepare a ball-like glass preform 4. Step 2: use a powder dispenser 17 to attach the fluorescent material 3 on surface of a cavity of a lower mold core 12. Step 3: put the glass preform 4 onto the cavity of the lower mold core 12. Step 4: use powder dispenser 17 to spray the fluorescent material 3 on the cavity of the upper mold core 11. Step 5: as the step 5 in the first embodiment, run the heating and pressuring process for molding. Step 6: cool down and reduce the pressure. Step 7: release the molded fluorescent glass lens 1.

### The Sixth Embodiment

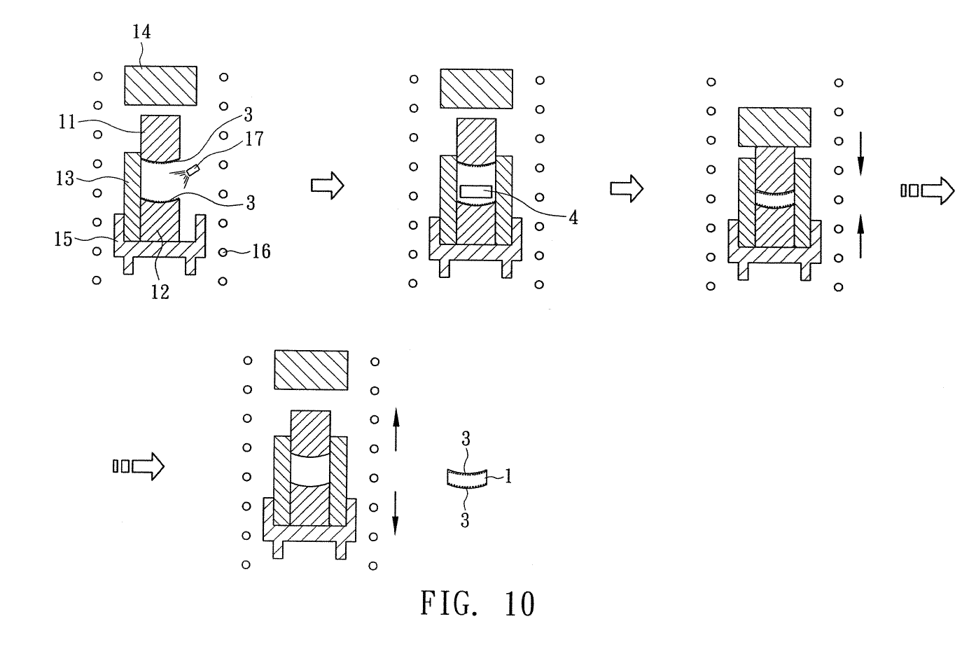

Refer to FIG. 10, step 1: prepare a cube-like glass preform 4. Step 2: use a powder dispenser 17 to attach the fluorescent material 3 on surface of a cavity of an upper mold core 11 and a lower mold core 12. Step 3: put the cube-like glass preform 4 onto the cavity of the lower mold core 12. Step 4: run a heating and pressuring molding process, as the step 5 in the first embodiment. Step 5: cool down and reduce the pressure. Step 6: release the molded fluorescent glass lens 1.

### The Seventh Embodiment

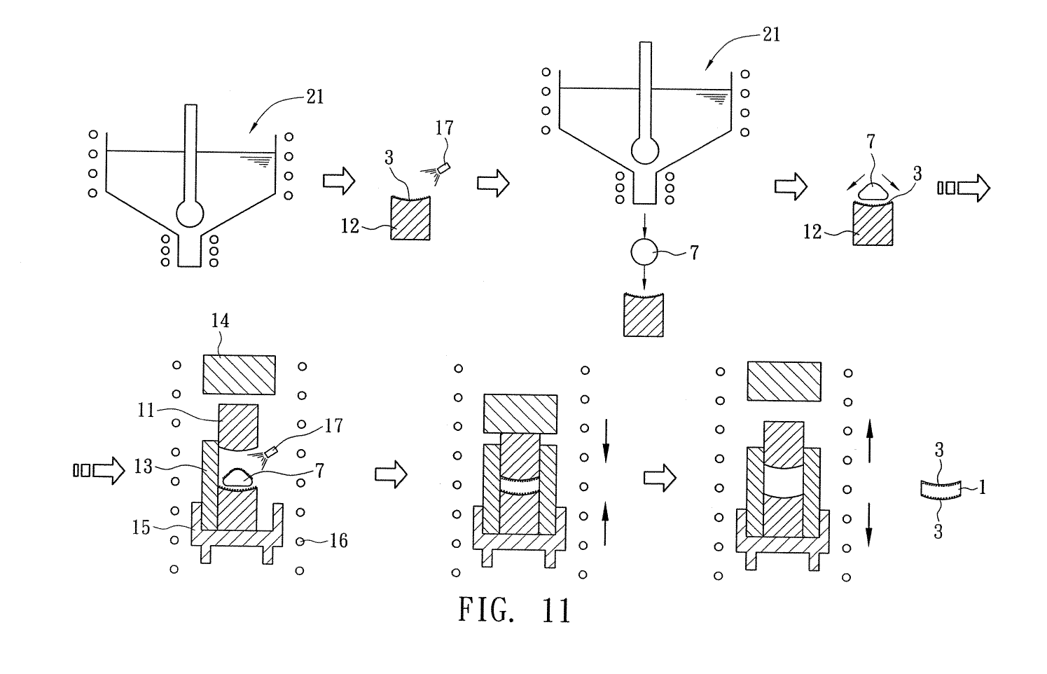

Refer to FIG. 11, put glass material into a glass melter 21 for being melt. Step 2: use a powder dispenser 17 to attach the fluorescent material 3 on surface of a cavity of a lower mold core 12. Step 3: the melt glass drop 7 is drop into the cavity of the lower mold core 12 with the fluorescent material 3. Step 4: use powder dispenser 17 to spray the fluorescent material 3 onto surface of the melt glass drop 7; if there is only one fluorescent surface, this step can be deleted. Step 5: as the step 5 in the first embodiment, run the heating and pressuring molding process. Step 6: cool down and reduce the pressure. Step 7: release the molded fluorescent glass lens 1.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A molded fluorescent glass lens comprising: a glass lens with preset shape and optical properties; and a fluorescent layer on surface of the glass lens formed by fluorescent material inserted into surface of the glass lens through a glass molding process.

2. The molded fluorescent glass lens as claimed in claim 1, wherein the lens is formed by the glass molding process and having preset shape and optical properties, wherein the fluorescent layer is formed by attaching the fluorescent material on a glass preform or a cavity of a mold core and the fluorescent material inserted into surface of the lens during heating and pressuring of the glass molding process.

3. The molded fluorescent glass lens as claimed in claim 1, wherein the fluorescent material is selected from YAG phosphor, TAG phosphor and nitride Phosphor.

4. The molded fluorescent glass lens as claimed in claim 1, wherein the fluorescent material is a single phosphor or combinations of phosphors.

5. The molded fluorescent glass lens as claimed in claim 4, wherein the fluorescent material is a mixture of red fluorescent material, yellow fluorescent material, and blue fluorescent material.

6. The molded fluorescent glass lens as claimed in claim 1, wherein the fluorescent layer is covered on whole surface area of the glass lens.

7. The molded fluorescent glass lens as claimed in claim 1, wherein the fluorescent layer is covered on a specific area of surface of the lens.

8. A manufacturing method of a molded fluorescent glass lens comprising the steps of:
preparing a glass preform;
attaching fluorescent material on a preset surface area of the glass preform;
putting the glass preform with the fluorescent material onto an upper mold core and a lower mold core of a mold;
heating the upper mold core and the lower old core until temperature is over glass transition temperature of the glass preform and the glass preform becomes soft; then pressuring the upper mold core and the lower mold cor so that the fluorescent material is inserted into surface of the glass preform and the glass preform is molded into the glass lens with preset shape by the upper mold core and the lower mold core;
cooling the glass lens, the upper mold core and the lower mold core, reducing the pressure for separating the upper mold core and the lower mold core; and
releasing a finished molded fluorescent glass lens.

9. The method as claimed in claim 8, wherein the fluorescent material in the step of attaching fluorescent material on a preset surface area of the glass preform is coated on the preset surface area by hand painting.

10. The method as claimed in claim 8, wherein the fluorescent material in the step of attaching fluorescent material on a preset surface area of the glass preform is coated on the preset surface area by a powder dispenser.

11. The method as claimed in claim 10, wherein the powder dispenser for attaching the fluorescent material is disposed with an electrostatic coating device.

12. A manufacturing method of a molded fluorescent glass lens comprising the steps of:
preparing a glass preform;
attaching fluorescent material on a preset area on surface of an upper mold core and/or a lower mold core of a glass molded forming equipment;
putting the glass preform onto the upper mold core and the lower mold core;
heating the upper mold core and the lower mold core until temperature is over glass transition temperature of the glass preform and the glass preform becomes soft; then pressuring the upper mold core and the lower mold core so that the fluorescent material is inserted into surface of the glass preform and the glass preform is molded into the glass lens with preset shape by the upper mold core and the lower mold core;
cooling the glass lens, the upper mold core and the lower mold core, reducing the pressure for separating the upper mold core and the lower mold core;
releasing a finished molded fluorescent glass lens.

13. The method as claimed in claim 12, wherein the fluorescent material in the step of attaching fluorescent material on a preset surface area of the glass preform is attached on the preset surface area by hand painting.

14. The method as claimed in claim 12, wherein the fluorescent material in the step of attaching fluorescent material on a preset surface area of the glass preform is attached on the preset surface area by a powder dispenser.

15. The method as claimed in claim 14, wherein the powder dispenser for attaching the fluorescent material is disposed with an electrostatic coating device.

16. The method as claimed in claim 12, wherein the glass preform is a melt glass drop.

17. The method as claimed in claim 8, wherein the glass preform is a melt glass drop.
